(19) United States
(12) Patent Application Publication
(10) Pub. No.: US 2005/0146276 A1
(43) Pub. Date: Jul. 7, 2005

(54) Image-geometry corrector for a cathode-ray tube

(76) Inventors: Nacerdine Azzi, Fontaine-Les-Dijon (FR); Olivier Masson, Dijon (FR); Jean Gastaud, Dijon (FR)

Correspondence Address: THOMSON LICENSING INC., PATENT OPERATIONS, PO BOX 5312, PRINCETON, NJ, 08543-5312, US

(21) Appl. No.: 10/499,539

(22) PCT Filed: Dec. 4, 2002
(86) PCT No.: PCT/EP02/13698

(30) Foreign Application Priority Data
Dec. 19, 2001 (FR) 0116465

(51) Int. Cl. H01J 23/08

(52) U.S. Cl. 315/5.35; 315/8

(57) ABSTRACT

Device for correcting the geometry of the image created on the screen of a cathode-ray tube, comprising a first set of four coils arranged in series one with the other, coiled on a magnetic core, the said coils being traversed by at least a portion of the horizontal deflection current, at least one permanent magnet intended to apply to the core a magnetic field oriented in one direction for one of the pairs of coils and in the opposite direction for the second pair, and a second set of two coils in series one with the other and arranged around the magnetic core so as to contain the magnetic fluxes created by the first set of coils, the two coils being traversed by at least part of the vertical deflection current and arranged so as to create, in the magnetic core, magnetic fluxes oriented in one direction in one of the pairs of coils of the first set and in the opposite direction in the second pair of the first set. The device makes it possible to correct both the horizontal and vertical geometrical defects.

The present invention relates to a magnetic device for correcting geometrical defects in the image created on the screen of a cathode-ray tube and is more particularly adapted to tubes whose front face has a high radius of curvature.

A cathode-ray tube intended to generate colour images generally comprises an electron gun emitting three electron beams, each beam being intended to excite a phosphor of a defined primary colour (red, green or blue) on the screen of the tube.

The electron beams scan the screen of the tube under the influence of the deflection fields created by a deflection device, also called a deflector, fixed to the neck of the tube, comprising coils for horizontally and vertically deflecting the said beams. Conventionally, a ring made of a ferromagnetic material surrounds the deflection coils so as to concentrate the deflection fields in the appropriate region.

The three beams generated by the electron gun must always converge on the screen of the tube otherwise an error called a convergence error is introduced, which distorts in particular the rendition of the colours. In order to make the three coplanar beams converge, it is known to use astigmatic deflection fields called self-converging fields; in a self-converging deflection coil, the intensity of the field or the lines of flux caused by the horizontal deflection winding are generally in the form of a pincushion in the region of a portion of the coil which is located somewhat to the front of the latter on the side of the screen of the tube. This amounts to introducing, into the distribution of the turns forming the line coil, a large positive third harmonic of the ampere-turn density to the front of the coil.

Moreover, due to the action of uniform horizontal and vertical deflection magnetic fields, the volume scanned by the electron beams is a pyramid whose apex is coincident with the centre of deflection of the deflector and whose intersection with a non-spherical screen surface presents a geometrical defect called a pincushion. This geometrical distortion of the image is greater the greater the radius of curvature of the screen of the tube. The self-convergent deflectors generate astigmatic deflection fields making it possible to modify the north/south and east/west geometry of the image and, in particular, partially compensate for the north/south pincushion distortion. The east/west geometrical defects are generally corrected by an electronic circuit associated with the deflector.

However, the current trend towards tubes having an increasingly flat screen surface, or even a completely flat surface, especially amplifies the problems of image geometry; the result of this is that the self-convergent deflectors can no longer completely correct the geometry of the north/south pincushion, while moreover, the east/west geometrical defects require increasingly strong corrections.

To correct these problems of image geometry, linked to the flatness of the screen and to the self-convergent deflection device equipping the tube, there are various solutions such as, for example, electronic correction devices illustrated by Patents U.S. Pat. No. 3,916,254 and U.S. Pat. No. 3,748,531, or transducers to correct the east/west pincushion defects as in application EP 776125.

However, the solutions described only make it possible to correct either the north/south pincushion, or the east/west pincushion which especially complicates the design of the device for correcting the geometrical defects of the tube equipped with its deflector. Moreover, the electronic correction circuits are generally developed by designers of the electronic frame generating all the functions of the television set in which the tube is inserted, the said designers preferring to buy, for reasons of cost, a tube where these geometrical faults are corrected beforehand.

The object of the invention is to provide an overall solution, correcting both the north/south and east/west geometrical defects, a solution taking the form of a magnetic device which can be loaded with the deflector so as to produce a tube which does not require an electronic geometrical correction device.

For this, the subject of the invention is a magnetic device for correcting the geometry of the image created on the screen of a cathode-ray tube, in the form of a saturable magnetic device comprising:
a first set of four coils placed in series one with the other, coiled on a magnetic core, the said coils being traversed by at least a portion of the horizontal deflection current, at least one permanent magnet intended to apply, to the core, a magnetic field oriented in one direction for one of the pairs of coils and in the opposite direction for the second pair,
characterized in that the magnetic device furthermore comprises:
a second set of two coils in series one with the other and arranged around the magnetic device so as to contain the magnetic fluxes created by the first set of coils, the two coils being traversed by at least part of the vertical deflection current and placed so as to create, in the magnetic core, magnetic fluxes oriented in one direction in one of the pairs of coils of the first set and in the opposite direction in the second pair of the first set.

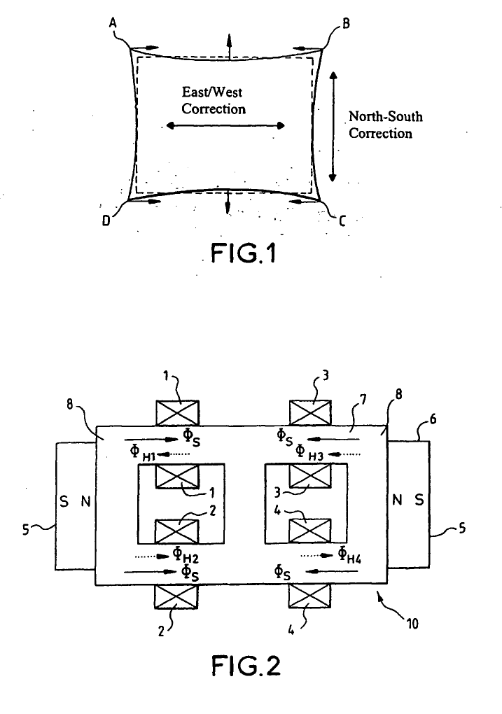

The invention and its various advantages will be better understood using the description below and the drawings of which:
FIG. 1 shows the geometrical distortions of the image which the invention aims to correct.

FIG. 2 illustrates a magnetic geometrical corrector according to the prior art.

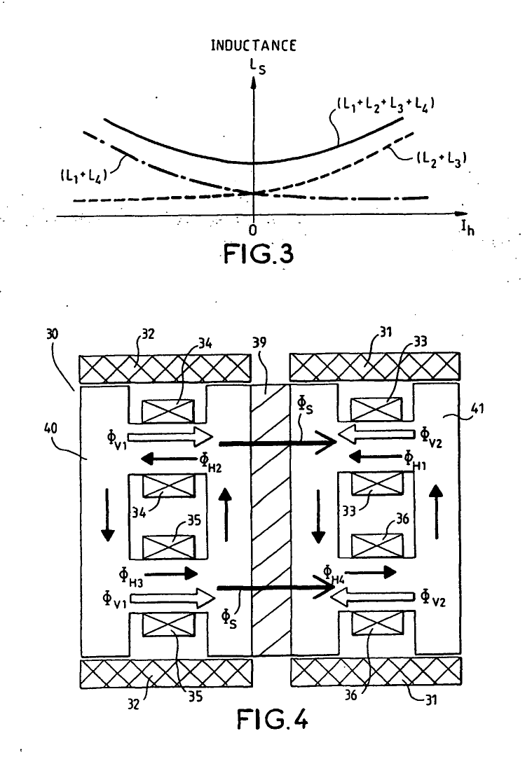

FIG. 3 is a diagram showing the variations of inductance in the embodiment according to the prior art.

FIG. 4 is an exemplary embodiment of a corrector according to the invention.

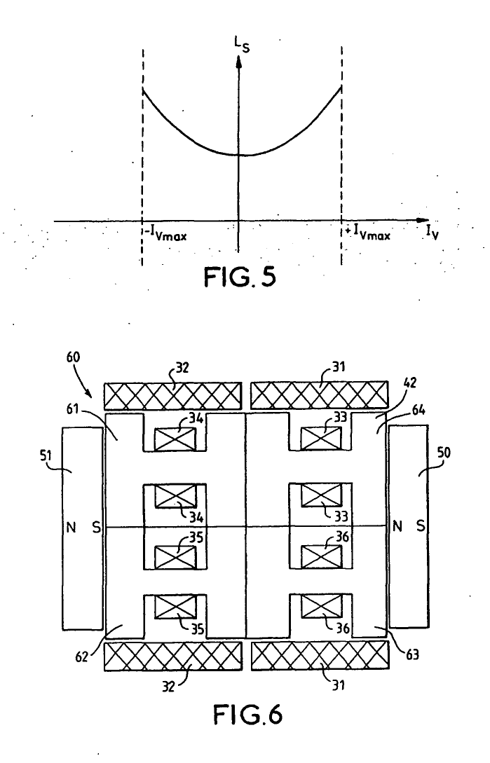

FIG. 5 is a diagram representing the variations of inductance according to the vertical deflection current.

FIG. 6 illustrates a second embodiment of the invention.

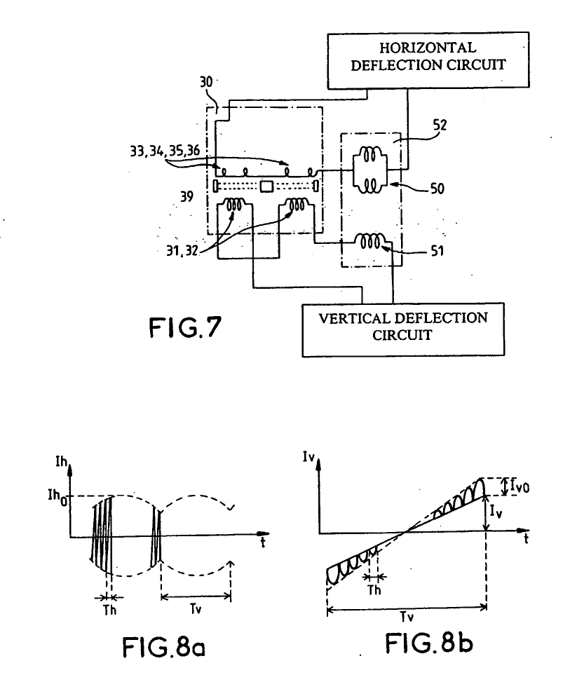

FIG. 7 shows the correction device according to the invention inserted in the deflection device of a cathode-ray tube.

FIGS. 8a and 8b show the variations of the deflection current as a function of time when they are modulated by the correction device according to the invention.

FIG. 1 illustrates the distortions which appear on the screen of a substantially flat cathode-ray tube, the image of a rectangle appearing in the form of a pincushion.

The invention aims to correct these geometrical defects by modification of horizontal and vertical deflection currents.

The presence of an east/west pincushion distortion means that the amplitude of the horizontal deflection current Iₕ at the centre of the screen is insufficient and that it must be compensated for by reducing the amplitude of Iₕ on the edges of the screen A, B, C, D. This effect must be obtained by modulating the amplitude of the horizontal deflection current at the frequency (1/Tᵥ) of the vertical deflection current. The shape of the horizontal current is then similar to that illustrated by FIG. 8a.

The presence of a north/south pincushion distortion means that the amplitude of the deflection current Iᵥ must be increased from the centre towards the upper and lower parts of the screen so as to “pull” the middles of the horizontal edges, AB and CD, of the image outwards, the amplitude of the increase having to be proportional to the value of the uncorrected vertical deflection current and the modulation frequency having to correspond to the frequency of the horizontal deflection current (1/Tₕ). FIG. 8b describes the shape of the vertical deflection current required.

FIG. 2 describes a magnetic device for correcting the horizontal geometrical distortion or east/west pincushion distortion. This device 10 comprises a magnetic core 7 around the arms of which are coiled four coils 1, 2, 3, 4, of respective inductance L1, L2, L3, L4, electrically connected in series and supplied by the horizontal deflection current. These coils create magnetic fluxes Φ_{H1}, Φ_{H2}, Φ_{H3}, Φ_{H3}, in the core in one direction for one pair of coils (1, 3) and in the opposite direction for the other pair (2, 4). Two permanent magnets 5 and 6 are placed at the ends 8 of the core. The magnets have a polarity chosen to create a magnetic flux Φₛ in the arms of the core, the direction of which is:
that of the flux created by one pair of coils,
opposite that of the flux created by the other pair of coils.

The core is magnetically saturated in the absence of a current in the coils 1, 2, 3, 4 by the flux Φₛ of the magnets 5 and 6: the inductance of the coil series is therefore a minimum.

When the amplitude of the current in the coils 1 to 4 increases, a progressive desaturation then occurs in the core, proportional to the current amplitude, under the pair of coils where the flux created by the deflection current opposes the flux Φₛ; it follows that the inductance of this pair increases with the current while the inductance of the other pair remains substantially constant. When the current Iₕ goes from its minimum value (−I_{h,max}) to its maximum value (I_{h,max}), the inductance Lₛ of the coils 1 to 4 connected in series will then change according to the curve illustrated by FIG. 3.

However this prior art does not solve the problems of correcting the north/south geometry of the image.

FIG. 4 is an illustration of a first embodiment of the invention.

The correction device comprises a first set of four coils 33, 34, 35, 36 successively connected in series and coiled around a saturable magnetic core separated into two parts 40, 41 by means of a permanent magnet 39 saturating the magnetic core by means of a longitudinal flux Φₛ. The coils 33 to 36 are coiled around the magnetic core such that the magnetic fluxes created by the pair of coils 33,34 (Φ_{H1},Φ_{H2}) are oriented longitudinally in one direction and the fluxes created by 35, 36 (Φ_{H3},Φ_{H4}) are oriented longitudinally in the opposite direction. The coils are supplied by all or some of the horizontal deflection current intended to supply the horizontal deflection coils of the cathode-ray tube.

The correction device furthermore comprises a second set of coils consisting of an external coil pair 31, 32, in series one with the other and placed around the magnetic core so as to contain the magnetic fluxes created by the set of coils 32 to 36, the two coils being traversed by at least part of the vertical deflection current intended to supply the vertical deflection coils of the cathode-ray tube; the coils 31 and 32 are arranged so as to create, in the magnetic core, a magnetic flux Φᵥ₁ oriented in one direction for one of the pairs of coils (34,35) of the first set and a magnetic flux Φ_{V2} oriented in the opposite direction in the second pair ( 36, 33) of the first set.

The various flux orientations indicated in FIG. 4 correspond to orientations due to currents which are positive by convention.

The force of the permanent magnet is preferably chosen so as to saturate the core (40,41) with a magnetic flux Φₛ in the absence of a horizontal and vertical deflection current.

As illustrated in FIG. 7, the correction device is loaded onto the deflector of the cathode-ray tube, the first set of coils 33 to 36 being connected in series with the horizontal deflection coils 50 of the deflector 52, the second set of coils 31, 32 being connected in series with the vertical deflection coils 51 of the said deflector.

The correction device operates as follows:

For the first set of coils 33 to 36:
the vertical deflection current Iᵥ, on going from zero to its maximum value I_{v,max}, will cause the progressive desaturation of the magnetic core under the pair of coils 33, 36; the result of this will be that the inductance of the coils 33 and 36 will increase with the current Iᵥ while the inductance of the coils 34, 35 will remain substantially constant. The inductance of the series of coils 33 to 36 in series will therefore increase with the current Iᵥ. This scenario is illustrated by FIG. 4.
on decreasing from its zero value to its minimum value −I_{v,max} the vertical deflection current Iᵥ will cause the progressive desaturation of the magnetic core under the coils pair 34, 35; the result of this will be that the inductance of the coils 34 and 35 will increase with the absolute value of the current Iᵥ while the inductance of the coils 33, 36 will remain substantially constant. The inductance of the series of coils 33 to 36 in series will therefore also increase with the current Iᵥ.
the result of this is that the overall inductance Lₛ of the series of coils 33 to 36 will vary as a function of the current Iᵥ as indicated in FIG. 5. Thus, the greater the vertical deflection current, the more the inductance Lₛ of the first set of coils will increase. Since Lₛ is placed in series with the horizontal deflection coils 50 of the deflector 52, the amplitude of the horizontal signal applied to these coils 50 will be reduced as a proportion of the said amplitude, thus providing the desired east/west pincushion correction. The current Iₕ will then change as indicated in FIG. 8a, with a maximum amplitude Iₕ₀ corresponding to the passage of the current Iᵥ through zero.

For the second-set of coils 31, 32:

Let us consider the situation for which the current l is at its maximum positive value.

In the configuration illustrated in FIG. 4, the fact that the magnetic circuits, on which the coils 34 and 35 are coiled, are saturated means that the variations in magnetic flux generated by the said coils are virtually zero, and do not induce any current in the coil 32 of the second set which overlaps them.

In contrast, the flux Φ_{V2} created by the coil 31 will desaturate the magnetic circuits around which the coils 33, 36 are coiled. If the coils 33 and 36 are considered as identical, the flux (Φ_{V2}+Φ_{H1}) in the circuit around which the coil 33 is coiled is greater than the flux (Φ_{V2}−Φ_{H4}) in the circuit around which the coil 36 is coiled. The variation in flux between the two coils 33 and 36 will induce a current I_{V0} in the coil 31 which will be superimposed with the current already flowing in the said coil.

An identical phenomenon will occur when the current Iᵥ is at its maximum negative value, in this case, the coils 32, 34 and 35 acting respectively like coils 31, 33 and 36.

Moreover, since the desaturation of the magnetic circuits is proportional to the amplitude of the said current Iᵥ, the increase I_{V0} in the amplitude of the current Iᵥ will also be proportional to the said current. The result of this is a modulation of the current Iᵥ according to FIG. 8b. This modulation makes it possible to pull the middles of horizontal lines of the image with an amplitude which is proportional to the amplitude of the uncorrected current Iᵥ.

In this way, the current in the vertical deflection coils will be according to FIG. 8b, thus providing the desired north/south pincushion correction.

The principle of the invention is not limited to the embodiment described above. FIG. 6 illustrates a second embodiment 60 of the geometrical correction device, no longer comprising one magnet in a central position but two magnets 50, 51 placed at the end of the core 42 so as to create therein a longitudinal magnetic flux like that of FIG. 4. This arrangement has the advantage of making the elements constituting the correction device 60 easier to manipulate, for example changing the force of the saturation magnets without having to touch the core/coils assembly. It is possible to combine the two embodiments of FIGS. 4 and 6, in particular to adapt a basic configuration of the correction device which would include a magnet in the central position to uses for various types of tubes using different deflection currents by the addition of magnets at the ends of the core 42.

In another embodiment of the invention (not shown) the permanent magnet 39 of the geometrical correction device is replaced by a coil coiled on a core placed in contact with the core (40, 41), the coil being supplied by a D.C. source in order to generate a longitudinal magnetic flux Φₛ in the said core. Although this configuration is more expensive, it has the advantage of being able to provide an element for additional adjustment of the flux Φₛ, making it possible to adapt the same geometrical correction device to several types of deflectors equipping various families of cathode-ray tubes.

In order to decrease the costs of fabrication and assembly of the device according to the invention, it is possible, as illustrated in FIG. 6, to produce the core 42 in four identical parts 61, 62, 63, 64; around each of these parts is coiled one of the identical coils 33,34,35,36 corresponding to the first set of coils in which flows all or some of the deflection current supplying the horizontal deflection coils of a deflector for a cathode-ray tube.

1. Magnetic geometry-correction device for a cathode-ray tube comprising:
a first set of four coils placed in series one with the other, coiled on a magnetic core, the said coils being traversed by at least a portion of the horizontal deflection current supplying the horizontal deflection coils of a deflector equipping the said tube,
magnetic means intended to apply to the core a magnetic field oriented in one direction for one of the pairs of coils and in the opposite direction for the second pair,
wherein the magnetic device furthermore comprises:
a second set of two coils in series one with the other and arranged around the magnetic core so as to contain the magnetic fluxes created by the first set of coils, the two coils being traversed by at least part of the vertical deflection current supplying the vertical deflection coils of the deflector equipping the said tube and placed so as to create, in the magnetic core, magnetic fluxes oriented in one direction in one of the pairs of coils of the first set and in the opposite direction in the second pair of the first set.

2. Magnetic device according to claim 1, wherein the magnetic core is made in two parts, the magnetic means being placed between the said two parts.

3. Magnetic device according to claim 1, wherein the magnetic means consist of at least one permanent magnet.

4. Magnetic device according to claim 1, wherein it comprises two permanent magnets placed at the ends of the magnetic core.

5. Magnetic device according to claim 2, wherein the magnetic means consist of a coil coiled on the magnetic core.

6. Magnetic device according to claim 1, wherein the magnetic means saturate the magnetic core in the absence of a deflection current.

7. Magnetic device according to claim 1, wherein the core is made in four parts, each of the coils being coiled around one of the said parts.

8. Cathode-ray tube comprising a device for correcting the image according to claim 1.
